(19) United States
(12) Patent Application Publication
(10) Pub. No.: US 2024/0307266 A1
(43) Pub. Date: Sep. 19, 2024

(54) VIAL ACCESS NEEDLE DEVICE

(71) Applicant: Heron Therapeutics, Inc., San Diego, CA (US)

(72) Inventors: Lee Ann Lynn Girotti, San Bruno, CA (US); Thomas B. Ottoboni, Belmont, CA (US)

(21) Appl. No.: 18/606,872

(22) Filed: Mar. 15, 2024

Related U.S. Application Data
(60) Provisional application No. 63/452,587, filed on Mar. 16, 2023.

(51) Int. Cl. A61J 1/20

(52) U.S. Cl. CPC A61J 1/2096; A61J 1/201; A61J 1/2055

(57) ABSTRACT

A vial access needle device is described. The device comprises a base with a base plate and with a base wall that extending proximally from the base plate. The base wall is configured to receive a portion of a base of a vial. The device also comprises a cap having a proximal closed end and configured to removably attach to the base, the proximal closed end having a proximal side and a distal side. A cap wall extends distally from the proximal closed end and is configured to receive a neck and a portion of the vial. The cap is configured to be removably attached to the base plate and to form an air-tight seal with the base.

### CROSS-REFERENCE TO RELATED APPLICATIONS

This application claims the benefit of priority to provisional patent application No. 63/452,587, filed Mar. 16, 2023, which is incorporated herein by reference in its entirety.

### TECHNICAL FIELD

The present technology relates vial access needle (“VAN”) devices generally and particularly VAN devices for use in sterile environments, such as an operating room.

### BACKGROUND

Liquid medication is typically provided to healthcare professionals and hospitals in vials. To access the medications contained in the vial, a doctor or clinician will typically extract the medication from the vial using a syringe. In order to prevent spilling and limit exposure of the fluid to the air, the top of the vial is often configured to contain a small opening suitable to receive the needle of the syringe. Accordingly, in order to extract the medication into the syringe, the user must first align the needle with the corresponding opening at the top of the vial, and then insert the needle. This process can present risks for the user. For example, if the needle is not properly aligned with the vial, the resulting contact may cause the needle to break, or accidentally prick the user.

To mitigate these risks, a clinician may use a VAN device. Such devices allow a clinician to safely access the medication in a drug vial without the risk of an accidental needle prick. VAN devices typically comprise a cap with a needle extending from the top of the cap. The top of the vial fits within the cap, and the needle enters the vial through the opening at the top of the vial. The VAN device also typically includes a luer connector, allowing the user to connect a syringe to the VAN device and thereby extract the medication through the needle.

The foregoing examples of the related art and limitations related therewith are intended to be illustrative and not exclusive. Other limitations of the related art will become apparent to those of skill in the art upon a reading of the specification and a study of the drawings.

### BRIEF SUMMARY

The following aspects and embodiments thereof described and illustrated below are meant to be exemplary and illustrative, not limiting in scope.

In one aspect, provided is a device comprising a base that comprises a base plate and a base wall. The base wall extends proximally from the base plate and the base wall is configured to receive a portion of a base of a vial or container. The device also comprises a cap having a proximal closed end and configured to removably attach to the base, where the proximal closed end having a proximal side and a distal side. The cap comprises a cap wall extending distally from the proximal closed end, where the cap wall is configured to receive a neck portion or other portion of the vial or container. In embodiments, the cap is configured to be removably attached to the base plate. In embodiments, the cap wall forms an air-tight seal with the base when attached to the base.

In one embodiment, the device further comprises a grip fixedly attached to the base. In an embodiment, the grip extends proximally from the base plate. In another embodiment, the grip surrounds the base wall.

In one embodiment, the distal side of the proximal closed end is configured to receive a needle. In an embodiment, the proximal side of the proximal closed end is configured to receive a syringe.

In one embodiment, the cap is configured to be removably attached to the base plate by inserting the cap wall between the grip and said base wall.

In an embodiment, the device is a medical device.

In another aspect, a medical device is provided. The medical device comprises a base that comprises a base plate; a base wall extending proximally from the base plate, where the base wall is configured to receive a portion of a base of a separate, external vial or container. The device further comprises a grip fixedly attached to the base, and, optionally, extending proximally from the base plate and surrounding the base wall. The device further comprises a cap having a proximal closed end and configured to removably attach to the base, the proximal closed end having a proximal side and a distal side. The cap comprises a cap wall extending distally from the proximal closed end; where the cap wall is configured to receive a neck or other portion of the vial or container. The distal side of the proximal closed end is configured to receive a needle (that is external to the device, and provided by the user of the device). The proximal side of the proximal closed end configured to receive a syringe (that is external to the device, and provided by the user of the device). The cap is configured to be removably attached to the base plate by inserting the cap wall between the grip and the base wall. In an embodiment, the cap wall forms an air-tight seal with the base when attached to the base.

In another aspect, a method for withdrawing a composition from its vial or container is provided. The method comprises providing a device as described herein and instructing to insert a vial or a container comprising composition into the device.

In an embodiment, the composition in the vial or container is a flowable composition. In an embodiment, the composition in the vial or container is semi-solid or viscous composition, or a non-viscous composition.

In an embodiment, the method further comprises withdrawing the composition from the container while it is inserted in the device. In an embodiment, withdrawing comprises withdrawing with a needle. In an embodiment, withdrawing comprises withdrawing with a needle attached to a barrel of a syringe.

In addition to the exemplary aspects and embodiments described above, further aspects and embodiments will become apparent by reference to the drawings and by study of the following descriptions.

Additional embodiments of the present device and its method of use will be apparent from the following description, drawings and claims. As can be appreciated from the foregoing and following description, each and every feature described herein, and each and every combination of two or more of such features, is included within the scope of the present disclosure provided that the features included in such a combination are not mutually inconsistent. In addition, any feature or combination of features may be specifically excluded from any embodiment of the present disclosure. Additional aspects and advantages of the present disclosure are set forth in the following description and claims, particularly when considered in conjunction with the accompanying examples and drawings.

### BRIEF DESCRIPTION OF THE DRAWINGS

FIG. 1 is a semi-transparent perspective view of an exemplary VAN device.

FIG. 2 is a cut-away perspective view of an exemplary VAN device.

FIG. 3 is a perspective view of the base of the exemplary VAN device.

FIG. 4 is a cut-away side view of an exemplary VAN device assembled together with a vial.

### DETAILED DESCRIPTION

### I. Definitions

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

Where a range of values is provided, it is intended that each intervening value between the upper and lower limit of that range and any other stated or intervening value in that stated range is encompassed within the disclosure. For example, if a range of 1 μm to 8 μm is stated, it is intended that 2 μm, 3 μm, 4 μm, 5 μm, 6 μm, and 7 μm are also explicitly disclosed, as well as the range of values greater than or equal to 1 μm and the range of values less than or equal to 8 μm.

The singular forms “a,” “an,” and “the” include plural referents unless the context clearly dictates otherwise. Thus, for example, reference to a “polymer” includes a single polymer as well as two or more of the same or different polymers, reference to an “excipient” includes a single excipient as well as two or more of the same or different excipients, and the like.

The term “about”, particularly in reference to a given quantity, is meant to encompass deviations of plus or minus five percent.

The compositions of the present disclosure can comprise, consist essentially of, or consist of, the components disclosed.

All percentages, parts and ratios are based upon the total weight of the compositions and all measurements made are at about 25° C., unless otherwise specified.

The phrase “pharmaceutically acceptable” is employed herein to refer to those compounds, salts, compositions, dosage forms, etc., which are—within the scope of sound medical judgment—suitable for use in contact with the tissues of human beings and/or other mammals without excessive toxicity, irritation, allergic response, or other problem or complication, commensurate with a reasonable benefit/risk ratio. In some aspects, “pharmaceutically acceptable” means approved by a regulatory agency of the federal or a state government, or listed in the U.S. Pharmacopeia or other generally recognized pharmacopeia for use in mammals (e.g., animals), and more particularly, in humans.

The term “treating” is used herein, for instance, in reference to methods of treating cancer, and generally includes the administration of a compound or composition which reduces the frequency of, or delays the onset of, symptoms of a medical condition (e.g., cancer) in a subject relative to a subject not receiving the compound or composition. This can include reversing, reducing, or arresting the symptoms, clinical signs, and underlying pathology of a condition in a manner to improve or stabilize a subject's condition (e.g., regression of tumor growth).

By reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by reserving the right to proviso out or exclude any individual substituents, analogs, compounds, ligands, structures, or groups thereof, or any members of a claimed group, less than the full measure of this disclosure can be claimed for any reason.

Throughout this disclosure, various patents, patent applications and publications are referenced. The disclosures of these patents, patent applications and publications in their entireties are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

For convenience, certain terms employed in the specification, examples and claims are collected here. Unless defined otherwise, all technical and scientific terms used in this disclosure have the same meanings as commonly understood by one of ordinary skill in the art to which this disclosure belongs.

### II. Device

Existing VAN devices are configured to fit over the top of a vial, leaving the body and bottom of the vial exposed. As vials cannot typically be sterilized before use, and are not kept in sterile environments, existing VAN devices are ill-suited for use in a sterile environment, such as an operating room. In this environment, a surface may be split into a sterile portion and a non-sterile portion. The vial is placed on the non-sterile surface and the cap, which has been sterilized, is applied over the top of the vial. A sterile syringe is then affixed to the luer connector and the medication is extracted. To prevent contamination of the sterile environment (sterile portion), the process of extracting medication must be tightly choreographed to ensure that non-sterile components or personnel do not make contact with sterile components or personnel. This process thus creates a heightened risk of contamination of the field.

As a consequence, there is a need in the art for a VAN device that can be used in a sterile environment without the need for non-sterile components or personnel to be present in the environment, and without the need to choreograph the process for drawing the medication out of the vial.

The present technology addresses these and other shortcomings by providing a VAN device that fully surrounds the vial, providing a sterile shield. A clinician may attach the VAN device to the vial outside of the sterile environment, thus obviating the need for any non-sterile surfaces or personnel to be present in proximately to the field.

An exemplary VAN device embodying the present technology includes a base plate including a base wall and a grip. The VAN device further includes a cap with a closed end and configured to removably attach to the base. The interior of the cap of the VAN device includes a needle configured to enter a vial. The exterior of the cap of the VAN device includes a connector, such as a luer connector, configured to receive a syringe. During use, a vial is placed on the base within the base wall. The cap is then affixed to the top of the vial and lowered onto the base plate, and the cap wall is attached to the base plate between the base wall and the grip. Optionally, this connection forms an air-tight seal between the base and the cap, allowing the exterior of the VAN device to remain sterile at all times. Because the VAN device completely surrounds the vial, no portion of vial can make contact with the outside.

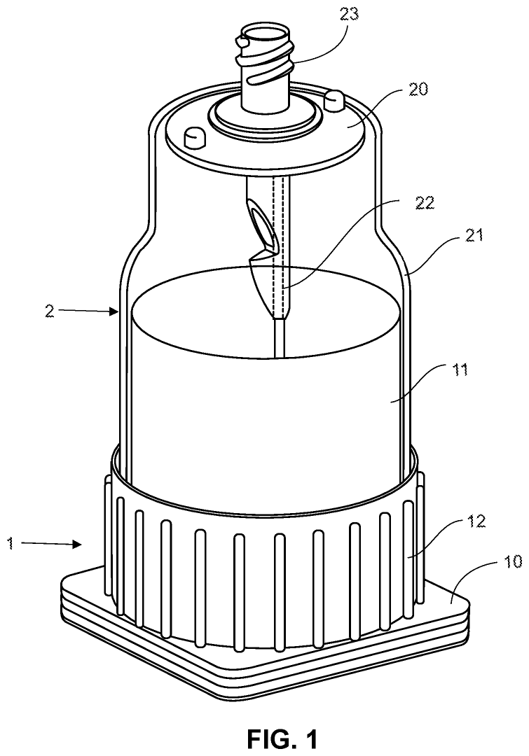

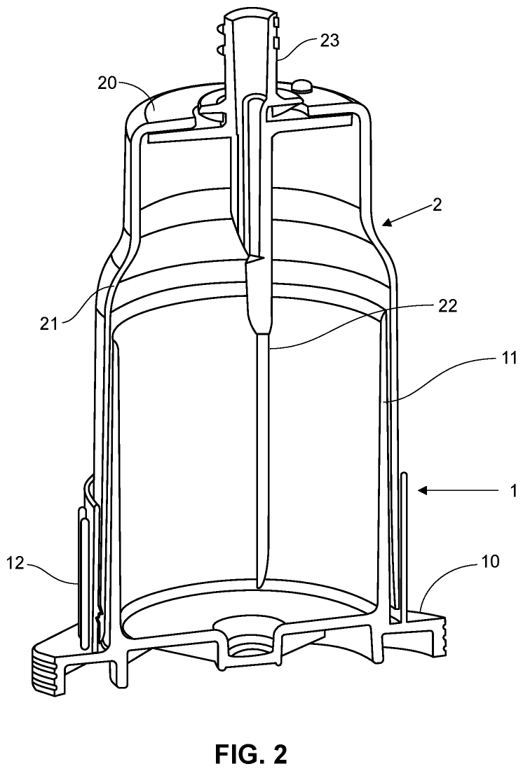

With reference to FIGS. 1-2, the exemplary VAN device as described in this specification is shown to include a base 1 at distal end of the VAN device. Base 1 comprises a base plate 10 and a base wall 11 extending proximally from the base plate 10. The base further comprises, in an embodiment, an optional grip 12. In an embodiment, the grip extends proximally from base plate 10 and surrounds a portion of base wall 11. The exemplary VAN device further includes a cap 2. Cap 2 comprises a proximal closed end 20 and a cap wall 21 extending distally from proximal closed end 20. Cap wall 21 is shaped to receive a neck and portion of a vial (not shown). The proximal side of proximal closed end 20 is configured to receive a needle 22. The distal side of proximal closed end 20 includes luer 23 that mates with a luer of a syringe (not shown), though other connectors may be used. Cap 2 is configured to be removably attached to base plate 10 by inserting cap wall 21 between grip 12 (if present) and base wall 11. Cap wall 21, optional grip 12, and base wall 11 are sized and configured such that cap wall 21 can be inserted between optional grip 12 and base wall 11, or between cap wall 21 and base wall 11 when grip 12 is not present. In an embodiment, cap wall 21, optional grip 12, and base wall 11 are sized and configured such that cap wall 21 can form an air-tight seal between cap 2 and base 1, thereby preventing the non-sterile vial from making contact with the sterile field.

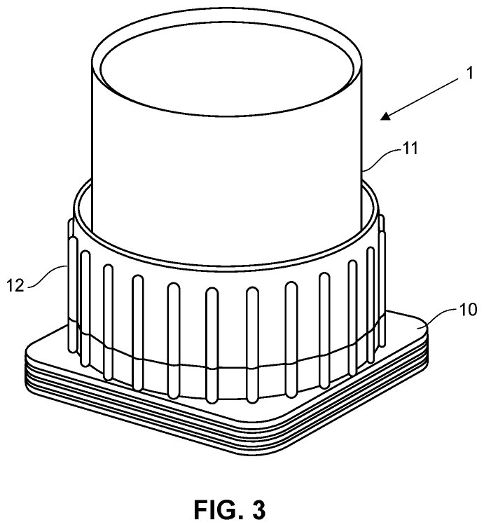

As shown in FIG. 2, base plate 10 does not contain any holes or openings, in an embodiment. As shown in FIG. 3, base wall 11 and, if present, grip 12 is/are fixedly attached to and extend distally from base plate 10. Accordingly base 1 comprises a solitary component that may be created by welding separate components together, or by forming base 1 in a single cast. This ensures that, after assembly, the base of the vial cannot make contact outside the VAN device.

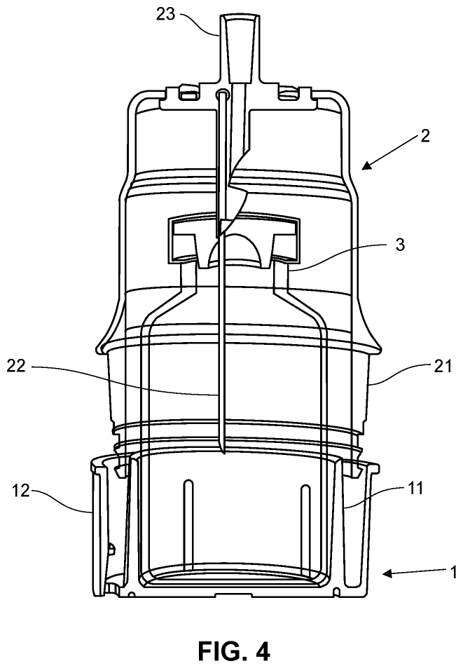

As shown in FIG. 4, to assemble the VAN device, a vial 3 is placed on the base 1. In some implementations, vial 3 is inserted into a cavity formed by base wall 11, e.g., such that vial 3 is secured by base wall 11. Cap 2 is then placed over the vial, and secured to the base 1, by securing cap wall 21 between base wall 11 and optional grip 12. In an embodiment, cap 2 is placed over the vial and secured to the base 1, by securing cap wall 21 between base wall 11, to form an air-tight seal between cap 2 and base 1. In embodiments, when cap 2 is then placed over the vial, needle 22 pierces the top of vial 3. When cap 2 is fully secured to base 1, needle 22 may extend through the top of vial 3, thereby allowing a composition, for example, a pharmaceutical medication, to be drawn out to a syringe (not shown) through luer 23. After assembly, vial 3 is completely enclosed by base 1 and cap 2. This process may be accomplished in a non-sterile environment, and does not require the presence of non-sterile components in the sterile environment. As previously noted, this allows the exterior of the VAN device to remain sterile, and prevents any portion of the non-sterile vial to come into contact with the sterile field.

### III. Method of Use

In another aspect, a method for administering a composition is provided. In an embodiment, the composition is a flowable composition. In an embodiment, the composition is a flowable, sterile composition, such as a pharmaceutical composition to be administered in vivo. In an embodiment, the composition is a semi-solid composition. In an embodiment, the composition is a semi-solid, sterile composition. As used herein “semi-solid” denotes the mechano-physical state of a material that is flowable under moderate stress. A semi-solid material may generally have a viscosity between about 1,000 and 3,000,000 mPa-s at 37° C., or a viscosity of between about 1,000 and 50,000 mPa-s at 37° C. Accordingly, in embodiments, the composition is a viscous composition that may have, for example, a viscosity of equal to or greater than about 100 cP (100 mPa-s) at 25° C. In embodiments, the composition is a viscous composition that may have, for example, a viscosity of equal to or greater than about 100 cP (100 mPa-s) at 25° C. and equal to or less than about 3,000,000 mPa-s at 37° C., 50,000 mPa-s at 37° C., 20,000 mPa-s at 37° C., or 10,000 mPa-s at 37° C. In an embodiment, the composition is a non-viscous composition, such as an aqueous based or organic solvent based composition. In embodiments, the non-viscous composition may have a viscosity of less than or equal to about 100 cP (100 mPa-s) at 25° C.

In one embodiment, the VAN is for use with a vial that comprises a semi-solid therapeutic compositions that comprises an active agent and a pharmaceutically acceptable excipient, where the semi-solid composition is intended for delivery via a needle. In embodiments, the needle is attached to a syringe. The semi-solid (or flowable) composition is removed from the vial via the needle and/or syringe, for administration to a subject in need. An “active agent” or “active ingredient” refers to any compound or mixture of compounds which produces a beneficial or useful result. Generally, “active agent” or “drug” refers to any organic or inorganic compound or substance having bioactivity and adapted or used for therapeutic purposes. Active agents are distinguishable from such pharmaceutically acceptable excipients or components, such as vehicles, carriers, diluents, lubricants, binders and other formulating aids, and encapsulating or otherwise protective components. Examples of active agents are pharmaceutical, agricultural or cosmetic agents. Suitable pharmaceutical agents include locally or systemically acting pharmaceutically active agents which may be administered to a subject by topical or intralesional application (including, for example, applying to abraded skin, lacerations, puncture wounds, etc., as well as into surgical wounds or incisions) or by injection, such as subcutaneous, intradermal, intramuscular, intraocular or intra-articular injection.

In an embodiment, the semi-solid therapeutic composition comprises as the pharmaceutically acceptable excipient a polymer. In an embodiment, the polymer is a bioerodible and/or biodegradable polymer. In an embodiment, the bioerodible and/or biodegradable polymer is a synthetic polymer. Exemplary polymers include polylactic acid poly(lactic-co-glycolic) acid, and polycaprolactone, each an exemplary biodegradable polymer. Another example are polyorthosesters, including the non-thermoplastic polyorthoesters described in U.S. Pat. Nos. 6,613,355 and 9,694,079, which are incorporated by reference herein. Although any polyorthoester may be used, a preferred polyorthoesters is composed of alternating residues resulting from reaction of a diketene acetal and a diol, where each adjacent pair of diketene acetal-derived residues is separated by the residue of a reacted diol. The polyorthoester may comprise a-hydroxy acid-containing subunits, i.e., subunits derived from an a-hydroxy acid or a cyclic diester thereof, such as subunits comprising glycolide, lactide, or combinations thereof, i.e., poly(lactide-co-glycolide), including all ratios of lactide to glycolide, e.g., 75:25, 65:35, 50:50, etc. Such subunits are also referred to as latent acid subunits; these latent acid subunits also fall within the more general “diol” classification as used herein, due to their terminal hydroxyl groups. Polyorthoesters can be prepared as described, for example, in U.S. Pat. Nos. 4,549,010 and 5,968,543, incorporated by reference herein.

In an embodiment, the polymer is a non-biodegradable and/or non-bioerodible polymer, such as silicone rubber, polyethylene, acrylic resins, polyurethane, polypropylene, and polymethylmethacrylate. In other embodiments, the polymer can be a biologically compatible synthetic and natural biodegradable polymer, such as a polyglycolide, a polylactide, polyhydroxobutyrate, polyethylene glycol, celluloses, chitosan, and hyaluronic acid.

In another embodiment, the pharmaceutically acceptable excipients form an oil phase to yield a flowable composition that is an emulsion, such as an oil-in-water emulsion. For example, the oil phase can comprise one or more of an emulsifier, an oil and a surfactant. An aqueous phase of the oil-in-water emulsion can comprise one or more of a tonicity agent and a pH-adjusting agent. The active agent can be lipophilic or hydrophilic, and will partition accordingly into the oil phase or aqueous phase of the emulsion. Exemplary oil-in-water emulsions are described, for example, in U.S. Pat. No. 9,808,465, incorporated by reference herein. In an embodiment, the oil of the oil-in-water emulsion is selected from the group consisting of structurally modified or hydrolyzed coconut oil, olive oil, soybean oil, safflower oil, triglycerides, octyl and decyl glycerate, ethyl oleate, glyceryl linoleate, ethyl linoleate, glyceryl oleate, cholesteryl oleate/linoleate or a mixture thereof. In an embodiment, the emulsifier is selected from the group consisting of egg phospholipids, soy phospholipids, phosphatidylcholines, phosphatidylethanolamines, phosphatidylserines, phosphatidylglycerols, phosphatidylinositols, phosphatidic acids, mixed chain phospholipids, lysophospholipids, hydrogenated phospholipids, partially hydrogenated phospholipids, and mixtures thereof. Other suitable emulsifiers include propylene glycol mono- and di-fatty acid esters, polyoxyethylene sorbitan fatty acid esters, polyoxyethylene fatty acid esters, polyoxyethylene-polyoxypropylene co-polymers and block co-polymers, salts of fatty alcohol sulphates, sorbitan fatty acid esters, esters of polyethylene-glycol glycerol ethers, oil and wax based emulsifiers, glycerol monostearate, and glycerine sorbitan fatty acid esters.

As mentioned, the flowable composition is provided to a user in a vial or container, where the composition in the vial or container is sterile and ready for in vivo administration. The exterior of the vial is not sterile. A method for withdrawing the flowable composition from its vial or container is provided. The method comprises providing a device as described herein and instructing to insert a vial or a container comprising the flowable composition into the device. In an embodiment, the method further comprises withdrawing the flowable composition from the container while it is inserted in the device. In an embodiment, withdrawing comprises withdrawing with a needle. In an embodiment, withdrawing comprises withdrawing with a needle attached to a barrel of a syringe. And, as can be appreciated from the disclosure herein, the flowable composition may be a semi-solid or viscous composition or a non-viscous composition.

The foregoing is for purposes of illustration of the device and its use. It will be readily apparent to those skilled in the art that the device may be modified or substituted in various ways without departing from the spirit and scope of the invention. It is intended, therefore, that the invention be defined by the scope of the claims which follow and that such claims be interpreted as broadly as is reasonable.

It is claimed:

1. A device comprising:
a base that comprises a base plate;
a base wall extending proximally from the base plate, the base wall being configured to receive a portion of the base;
a cap having a proximal closed end and configured to removably attach to the base, the proximal closed end having a proximal side and a distal side,
wherein the cap comprises a cap wall extending distally from the proximal closed end, the cap wall being configured to receive a neck and a portion of the vial; and
wherein the cap is configured to be removably attached to the base plate.

2. The device of claim 1, further comprising a grip fixedly attached to the base.

3. The device of claim 2, wherein the grip extends proximally from the base plate.

4. The device of claim 2, wherein the grip surrounds the base wall.

5. The device of claim 1, wherein the cap wall forms an air-tight seal with the base when attached to the base.

6. The device of claim 1, wherein the distal side of the proximal closed end is configured to receive a needle.

7. The device of claim 1, wherein the proximal side of said proximal closed end is configured to receive a syringe.

8. The device of claim 2, wherein the cap is configured to be removably attached to the base plate by inserting the cap wall between the grip and the base wall.

9. A medical device comprising:
a base that comprises a base plate;
a base wall extending proximally from the base plate, the base wall being configured to receive a portion of the base;
a grip fixedly attached to the base, the grip extending proximally from the base plate and surrounding the base wall;
a cap having a proximal closed end, which is configured to removably attach to the base, the proximal closed end having a proximal side and a distal side;
wherein the cap comprises a cap wall extending distally from the proximal closed end, the cap wall being configured to receive a neck and a portion of the vial;
wherein a distal side of the proximal closed end is configured to receive a needle,
wherein a proximal side of the proximal closed end is configured to receive a syringe, and
wherein the cap is configured to be removably attached to the base plate by inserting the cap wall between the grip and the base wall.

10. The medical device of claim 9, wherein the cap wall forms an air-tight seal with the base when attached to the base.

11. A method for withdrawing a composition from its container, comprising inserting a container comprising the composition into the device of claim 1.

12. The method of claim 11, wherein the composition is withdrawn from the container while it is inserted in the device.

13. The method of claim 12, wherein the composition is withdrawn with a needle.

14. The method of claim 13, wherein the needle is attached to a barrel of a syringe.

15. The method of claim 11, wherein the composition is a flowable composition.

16. The method of claim 15, wherein the flowable composition is a semi-solid composition or a non-viscous composition.

17. The method of claim 16, wherein the semi-solid composition has a viscosity of greater than about 100 cP at 25° C. and less than about 50,000 cP at 37° C., or greater than about 100 cP at 25° C. and less than about 30,000 cP at 37° C.

18. The method of claim 16, wherein the semi-solid composition has a viscosity of between about 1,000 and 50,000 cP at 37° C.

19. The method of claim 16, wherein the non-viscous composition has a viscosity of less than or equal to 100 cP at 25° C.
